(19) United States
(12) Patent Application Publication
(10) Pub. No.: US 2019/0270925 A1
(43) Pub. Date: Sep. 5, 2019

(54) METHOD OF DRILLING A SUBTERRANEAN GEOLOGICAL FORMATION

(71) Applicant: King Fahd University of Petroleum and Minerals, Dhahran (SA)

(72) Inventors: Mohamed MAHMOUD, Dhahran (SA); Salaheldin ELKATATNY, Dhahran (SA)

(73) Assignee: King Fahd University of Petroleum and Minerals, Dhahran (SA)

(21) Appl. No.: 15/908,957

(22) Filed: Mar. 1, 2018

(51) Int. Cl. C09K 8/28; C09K 8/26; E21B 7/00; E21B 21/00

(52) U.S. Cl. CPC C09K 8/28; E21B 21/003; E21B 7/00; C09K 8/265

(57) ABSTRACT

A method of drilling a subterranean geological formation having a permeability of no more than 0.1 mD with a drilling fluid comprising a continuous phase, a viscosifier, a weighting agent, and sodium silicate, wherein the sodium silicate is present in the drilling fluid at a concentration of 0.01-0.2% by weight, relative to the total weight of the drilling fluid. Various combinations of embodiments of the drilling fluid and the method of drilling the subterranean geological formation are provided.

### BACKGROUND OF THE INVENTION

### Technical Field

The present invention relates to a method of drilling a subterranean geological formation with a permeability of no more than 0.1 mD.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

When a well is drilled, a drilling fluid (also known as a drill-in fluid) is circulated into the hole to contact the region of the drill bit for a number of reasons, such as cooling the drill bit, carrying the rock cuttings away from the point of drilling, and maintaining a hydrostatic pressure on the formation wall to prevent production during drilling. Drilling fluids are expensive particularly in light of the enormous quantities that need to be used during drilling. A portion of the drilling fluid is usually lost by leaking off into the formations during a drilling operation (also known as a “fluid loss”). This causes an increase in the cost of the drilling operation and damages the formation, since components of the drilling fluid may deposit in the pores of the formation, plug the flow channels, and reduce the permeability of the formation. To limit drilling fluid losses, preserve the integrity of the drilling fluid, prevent formation damages, and provide a balanced density, the drilling fluid is often modified by a weighting material that may form a coating, or “filter cake,” on the walls of the wellbore. The filter cake should be a thin and a low permeable layer that can be quickly formed during drilling.

A good drilling fluid should have degradable solids and a reduced amount of fluid loss, and should not be chemically reactive with formation fluid or swellable with the formation. See Mandal N. G., Jain U. K., Anil Kumar B. S., Gupta A. K. 2006. Non-damaging Drilling Fluid Enhances Borehole Quality and Productivity in Conventional Wells of Mehsana Asset, North Cambay Basin. SPE/IADC Paper 102128 presented at the SPE/IADC Indian Drilling Technology Conference and Exhibition, Mumbai, India. In addition, a good drilling fluid should have a high rate of penetration. Mitchell et al. stated that the rate of penetration of a drilling fluid is a strong function of the drilling fluid properties such as density, viscosity, and solid percent. See Mitchell R. F., and Miska, S. Z, 2011, Fundamentals of Drilling Engineering, Society of Petroleum Engineers. They revealed that an increase in any of these properties will reduce the rate of penetration. In a separate study, Estes concluded that an increase in the drilling fluid viscosity will reduce the rate of penetration if the bit is not contaminated. See Estes, J. C. 1974. Guidelines for Selecting Rotary Insert Rock Bits. Pet. Eng. Also, Hussaini et al. and Rao et al. reported that the rheological properties, e.g. viscosity, affect the rate of penetration of the drilling fluid when the annular velocity of the drill bit is less than 120 ft/min. See Hussaini, S. M. and Azar, J. J, 1983, Experimental Study of Drilled Cutting Transport Using Common Drilling Muds. SPE Journal 23 (1): 11-20; Rao M. A., Rheology of Fluid and Semisolid Foods, 2nd Edition, Springer Science and Business Media LLC, New York, USA 2007. Furthermore, Zhang et al. stated that additional parameters need to be considered for hydraulics calculations of a drilling fluid beside the rheological properties. These parameters include the solid percentage of the drilling fluid and the wellbore diameter. See Zhang, F., Miska, S., Yu, M., Ozbayoglu, E. M., and Takach, N. 2015. Pressure Profile in Annulus: Solids Play a Significant Role. Journal of Energy Resources Technology 137 (6): 064502-1-9. They concluded that at low flow rates, the drilling fluid solids content affected the pressure profile while at high flow rate the effect on the pressure profile is decreased.

However, in unconventional (or tight) reservoirs, i.e. reservoirs with a permeability of less than 0.1 mD, choosing a suitable drilling fluid remains a challenge, since formation damages caused by the drilling fluids are more severe than those in conventional reservoirs. The wellbores that are drilled in tight reservoirs mainly suffer from water blockage. In these reservoirs, water-based drilling fluids generally interact with the formation, wherein water fills small pores due to the existing capillary forces, thereby causing water blockage in the formation. The water blockage is a type of formation damage that significantly inhibits production rates in unconventional reservoirs.

Several research studies have been conducted to find a solution to prevent formation damages and water blockage in unconventional reservoirs. Lake et al. proposed hydraulic fracturing as a stimulation treatment to increase the production rates of tight reservoirs. See Lake L. W., Fanchi J. R., Mitchell R. F., Arnold K. E., Clegg J. D., Holstein E. D., Warner Jr. H. R. Petroleum Engineering Handbook, Vol. 6, Society of Petroleum Engineers, Texas, USA, 2007. In a separate study, Van Zanten et al. studied the effect of some surfactant additives added to water or brine-based drilling fluids in altering wettability and elimination of emulsion and water blockage in tight formations. See Van Zanten R., Horton D., Tanche-Larsen P, 2011, Engineering Drill-in Fluids to Improve Reservoir Producibility. SPE Paper 143845 presented at the SPE European Formation Damage Conference, Noordwijk, Netherlands. The authors also reported that two common damage types that are caused by lubricant and corrosion inhibitor additives were reduced after using the surfactant additives. El Bialy et al. proposed a drilling fluid formulate that contains potassium formate (KCOOH) brine and manganese tetra oxide (Mn₃O₄). See El Bialy M., Mohsen M., Ezell R. G., Abdulaziz M. E., Kompantsev A., Khakimov A., Ganizade F., Ashoor A. 2011. Utilization of Non-Damaging Drilling Fluid Composed of Potassium Formate Brine and Manganese Tetra Oxide to Drill Sandstone Formation in Tight Gas Reservoir. SPE/IADC Paper 147983 presented at the SPE/IADC Middle East Drilling Technology Conference and Exhibition, Muscat, Oman. The drilling fluid had a density of 114 lb/ft³ that was used for drilling a vertical well in a sandstone tight reservoir in Saudi Arabia. In this study, the drilling fluid revealed a reduced friction and drag during drilling, due to a reduced particle size and spherical shape of manganese tetra oxide present in the drilling fluid. The authors further stated that since manganese tetra oxide is acid and enzyme soluble, a return permeability of the reservoir after the drilling operation was about 99.3% with less than 14 ml of the filtrate volume.

In view of the forgoing, one objective of the present disclosure is to provide a method of drilling a subterranean geological formation having a permeability of no more than 0.1 mD with a drilling fluid comprising a continuous phase such as a water-based fluid or an oil-based fluid, a viscosifier, a weighting agent, and sodium silicate, which is present in the drilling fluid at a concentration of 0.01-0.2% by weight, relative to the total weight of the drilling fluid. During the drilling, the drilling fluid forms a filter cake with a thickness of no more than 2 mm and a total fluid loss of no more than 5% by volume relative to the total volume of the drilling fluid. The filter cake can be easily removed, and a permeability of the formation after removing the formation is substantially the same as the permeability of the formation before the drilling.

### BRIEF SUMMARY OF THE INVENTION

According to a first aspect, the present disclosure relates to a drilling fluid, including i) a continuous phase selected from the group consisting of a water-based fluid and an oil-based fluid, ii) a viscosifier, iii) a weighting agent, iv) sodium silicate, which is present in the drilling fluid at a concentration of 0.01-0.2% by weight, relative to the total weight of the drilling fluid.

In one embodiment, the sodium silicate is present in the drilling fluid at a concentration of 0.06-0.08% by weight, relative to the total weight of the drilling fluid.

In one embodiment, the viscosifier is bentonite, which is present in the drilling fluid at a concentration of 0.1-10% by weight, relative to the total weight of the drilling fluid. In one embodiment, the weighting agent is barite, which is present in the drilling fluid at a concentration of 40-60% by weight, relative to the total weight of the drilling fluid.

In one embodiment, the drilling fluid further comprises at least one additive selected from the group consisting of an antiscalant, a deflocculant, a lubricant, a crosslinker, a breaker, a fluid-loss control agent, a buffer, a surfactant, and a biocide.

In one embodiment, the continuous phase is the water-based fluid.

In one embodiment, the drilling fluid has a pH of at least 9.

In one embodiment, the drilling fluid has a density of 13 to 16 ppg at a temperature of 65 to 90° F.

In one embodiment, the drilling fluid has a plastic viscosity of 25 to 40 cP at a temperature of 65 to 90° F., and a plastic viscosity of 15 to 25 cP at a temperature of 100 to 180° F.

In one embodiment, the drilling fluid has a yield point of 65 to 80 lb/100 ft² at a temperature of 65 to 90° F., and a yield point of 45 to 55 lb/100 ft² at a temperature of 100 to 180° F.

In one embodiment, the drilling fluid has a yield point to plastic viscosity ratio of 2.4:1 to 3.0:1, at a temperature of 100 to 180° F.

In one embodiment, the drilling fluid has a ten-second gel strength of 15 to 20 lb/100 ft² at a temperature of 65 to 90° F., and a ten-second gel strength of 10 to 15 lb/100 ft² at a temperature of 100 to 180° F.

In one embodiment, the drilling fluid has a ten-minute gel strength of 20 to 25 lb/100 ft² at a temperature of 65 to 90° F., and a ten-minute gel strength of 15 to 20 lb/100 ft² at a temperature of 100 to 180° F.

According to a second aspect, the present disclosure relates to a method of drilling a subterranean geological formation with a permeability of no more than 0.1 millidarcy; the method involving i) drilling the subterranean geological formation to form a wellbore therein, ii) circulating the drilling fluid in the wellbore, wherein during the circulating a filter cake comprising the weighting agent is formed on a wall of the wellbore.

In one embodiment, the subterranean geological formation is a sandstone formation.

In one embodiment, the continuous phase is the water-based fluid, wherein a percent loss of the drilling fluid during the circulating is no more than 5% by volume, relative to the total volume of the drilling fluid.

In one embodiment, the drilling fluid is circulated in the wellbore for no more than 1 hour, wherein a thickness of the filter cake is no more than 2 mm.

In one embodiment, the method further involves removing the filter cake from the wellbore, wherein the permeability of the subterranean geological formation after the removing is reduced by no more than 10%, relative to the permeability of the subterranean geological formation before the circulating.

In one embodiment, the method further involves removing the filter cake from the wellbore, wherein the permeability of the subterranean geological formation after the removing is substantially the same as the permeability of the subterranean geological formation before the circulating.

In one embodiment, the method does not involve a step of removing the filter cake.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 represents a density of a drilling fluid that comprises sodium silicate at room temperature, with respect to the concentration of the sodium silicate.

FIG. 2 represents a pH of a drilling fluid that comprises sodium silicate at room temperature, with respect to the concentration of the sodium silicate.

FIG. 3 represents a plastic viscosity of the drilling fluid at various temperatures, with respect to the concentration of the sodium silicate.

FIG. 4 represents a yield point of the drilling fluid at various temperatures, with respect to the concentration of the sodium silicate.

FIG. 5 represents a ten-second gel strength of the drilling fluid at various temperatures, with respect to the concentration of the sodium silicate.

FIG. 6 represents a ten-minute gel strength of the drilling fluid at various temperatures, with respect to the concentration of the sodium silicate.

FIG. 7 is an image of an experimental set-up for measuring a solubility of barite in the drilling fluid.

FIG. 8 represents the solubility of barite in the drilling fluid at 200° F., with respect to the concentration of the sodium silicate.

FIG. 9 represents a cumulative filtrate volume of drilling fluids with various concentration of sodium silicate over a time period of 30 minutes, wherein the cumulative filtrate volume is measured under a static condition at a pressure of 300 psi and a temperature of 300° F.

FIG. 10 represents a thickness of a filter cake that forms after using the drilling fluids with various concentration of sodium silicate.

FIG. 11 represents a computer tomography scan of a tight sandstone core before circulating the drilling fluid, and after removing the filter cake.

### DETAILED DESCRIPTION OF THE EMBODIMENTS

The present disclosure will be better understood with reference to the following definitions. As used herein, the words “a” and “an” and the like carry the meaning of “one or more.” Within the description of this disclosure, where a numerical limit or range is stated, the endpoints are included unless stated otherwise. Also, all values and subranges within a numerical limit or range are specifically included as if explicitly written out.

The term “substantially the same” as used in this disclosure refers to an embodiment or embodiments wherein a difference between two quantities are no more than 2%, preferably no more than 1%, preferably no more than 0.5% of the smaller value of the two quantities.

According to a first aspect, the present disclosure relates to a drilling fluid, which includes a continuous phase such as a water-based fluid or an oil-based fluid.

In a preferred embodiment, the continuous phase is a water-based fluid. As used here, the term “water-based fluid” refers to any water containing solution, including saltwater, hard water, and/or fresh water. Accordingly, the term “saltwater” may include saltwater with a chloride ion content in the range of between about 6,000 ppm and saturation, and is intended to encompass seawater and other types of saltwater including groundwater containing additional impurities typically found therein. The term “hard water” may include water having mineral concentrations between about 2,000 mg/L and about 300,000 mg/L. The term “fresh water” may include water sources that contain less than 6,000 ppm, preferably less than 5,000 ppm, preferably less than 4,000 ppm, preferably less than 3,000 ppm, preferably less than 2,000 ppm, preferably less than 1,000 ppm, preferably less than 500 ppm of salts, minerals, and/or any other dissolved solids. Salts that may be present in saltwater, hard water, and/or fresh water may be, without limitation, cations such as sodium, magnesium, calcium, potassium, ammonium, and iron, and anions such as chloride, bicarbonate, carbonate, sulfate, sulfite, phosphate, iodide, nitrate, acetate, citrate, fluoride, and nitrite. In some embodiments, the water-based fluid is present as the continuous phase in the drilling fluid with a mass concentration of at least 40 wt %, preferably at least 50 wt %, preferably at least 60 wt %, preferably at least 70 wt %, preferably 80 wt % to 90 wt % in the drilling fluid, relative to the total weight of the drilling fluid. The water-based fluid may be supplied from a natural source, such as an aquifer, a lake, and/or an ocean, and may be filtered to remove large solids before being used in the drilling fluid. In a preferred embodiment, the water-based fluid is seawater with a total dissolved solid in the range of 30,000 to 60,000 mg/L, preferably 35,000 to 59,000 mg/L, preferably 40,000 to 58,000 mg/L, preferably 50,000 to 57,000 mg/L, preferably about preferably 55,000 mg/L. Water that is supplied from bays, lakes, rivers, creeks, and/or underground water resources may also be referred to as “seawater.”

In one embodiment, the continuous phase is an oil-based fluid, which may be one or more of diesel, petroleum, fuel oil, biodiesel, biomass to liquid (BTL) fuel, gas to liquid (GTL) diesel, mineral oil, an ester, an alpha-olefin, a natural oil, and derivatives and/or combinations thereof. The oil-based fluid preferably does not include an aqueous phase dispersed therein, although in certain embodiments, the oil-based fluid may include less than 5% by weight, preferably less than 2% by weight, preferably less than 1% by weight of an aqueous phase dispersed therein, for example, in a form of an invert emulsion. The weight percentiles are relative to the total weight of the continuous phase.

In a preferred embodiment, the drilling fluid does not include a mineral acid such as nitric acid, sulfuric acid, phosphoric acid, perchloric acid, hydrofluoric acid, hydrobromic acid, hydroiodic acid, boric acid, etc. In another preferred embodiment, the drilling fluid does not include an organic acid such as formic acid, acetic acid, propionic acid, butyric acid, valeic acid, caproic acid, oxalic acid, lactic acid, malic acid, citric acid, carbonic acid, benzoic acid, phenolic acid, uric acid, etc.

The drilling fluid further includes a viscosifier. As used herein, the term “viscosifier” refers to an additive for controlling a viscosity of the drilling fluid. In a preferred embodiment, the viscosifier is bentonite, which is preferably present in the drilling fluid at a concentration of 0.1-10% by weight, preferably 0.5-5% by weight, preferably 0.8-1.0% by weight, relative to the total weight of the drilling fluid. Additional compounds may be present in the bentonite, for example, potassium-containing compounds, iron-containing compounds, etc. There are different types of bentonite, named for the respective dominant element, such as potassium (K), sodium (Na), calcium (Ca) and aluminum (Al). In view of that, the term “bentonite” may refer to potassium bentonite, sodium bentonite, calcium bentonite, aluminum bentonite, and/or mixtures thereof, depending on the relative amounts of potassium, sodium, calcium, and aluminum present in the bentonite. In certain embodiments, the viscosifier is one or more of bauxite, dolomite, limestone, calcite, vaterite, aragonite, magnesite, taconite, gypsum, quartz, marble, hematite, limonite, magnetite, andesite, garnet, basalt, dacite, nesosilicates or orthosilicates, sorosilicates, cyclosilicates, inosilicates, phyllosilicates, tectosilicates, kaolins, montmorillonite, fullers earth, and halloysite and the like. In some embodiments, the viscosifier may be a thickening agent such as XC-polymer, xanthan gum, guar gum, glycol, and mixtures thereof. In some alternative embodiments, the viscosifier may be a natural polymer such as hydroxyethyl cellulose (HEC), carboxymethylcellulose, polyanionic cellulose (PAC), or a synthetic polymer such as poly(diallyl amine), diallyl ketone, diallyl amine, styryl sulfonate, vinyl lactam, laponite, polygorskites (e.g. attapulgite, sepiolite), and mixtures thereof. The viscosifier may be present in any amount in the range of 0.01 to 20 wt %, preferably 0.05 to 15 wt %, preferably 0.1 to 10 wt %, preferably 0.5 to 5.0 wt %, relative to the total weight of the drilling fluid.

The drilling fluid further includes a weighting agent. The term “weighting agent” as used herein refers to particles that increase an overall density of the drilling fluid in order to provide sufficient bottom-hole pressure to prevent an unwanted influx of formation fluids, e.g., during a drilling operation. In a preferred embodiment, the weighting agent is barite with a particle size of no more than 100 μm, preferably no more than 90 μm, preferably no more than 80 μm, preferably 40 to 60 μm. In view of that, the barite is present in the drilling fluid at a concentration of 40-60% by weight, preferably 45-55% by weight, preferably 48-52% by weight, relative to the total weight of the drilling fluid. Additional weighting agents may also be utilized in the drilling fluid including, without limitation, calcium carbonate (chalk), sodium sulfate, hematite, siderite, ilmenite, and combinations thereof. The additional weighting agents, when present, may have a mass concentration of no more than 20 wt %, preferably no more than 15 wt %, preferably in the range of 5.0 wt % to 15 wt %, preferably 6.0 wt % to 10 wt %, preferably 7.0 wt % to 8.0 wt %, relative to the total weight of the drilling fluid. In some embodiments, the weighting agent may be in a particulate form with an average particle size of no more than 50 μm, preferably in the range of 20 to 40 μm.

The drilling fluid further includes sodium silicate (Na₂SiO₃), which is present in the drilling fluid at a concentration of 0.01-0.2% by weight, preferably 0.02-0.15% by weight, preferably 0.03-0.12% by weight, preferably 0.04-0.1% by weight, preferably 0.05-0.09% by weight, preferably 0.06-0.08%, preferably about 0.075% by weight, relative to the total weight of the drilling fluid. In a preferred embodiment, the concentration of the sodium silicate in the drilling fluid does not exceed 0.3% by weight, preferably 0.2% by weight, preferably 0.15% by weight. The sodium silicate may preferably be present in the drilling fluid in one or more hydrate forms with a chemical formula Na₂SiO₃.nH₂O, wherein n is a positive integer in the range of 1 to 10, preferably 5, 6, 8, and 9. In some embodiments, a weight ratio of SiO₂ to Na₂O in the sodium silicate is in the range of 2:1 to 4:1, preferably 2.1:1 to 3:1, more preferably 2.2:1 to 2.9:1.

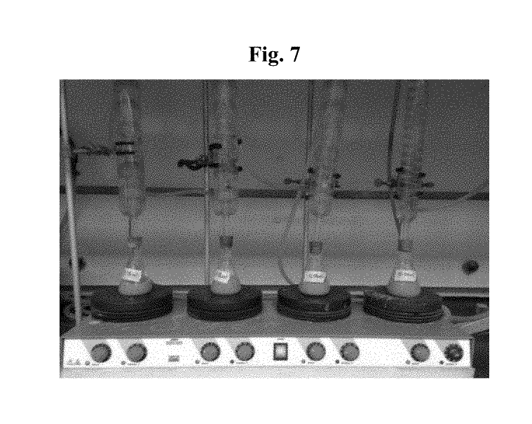

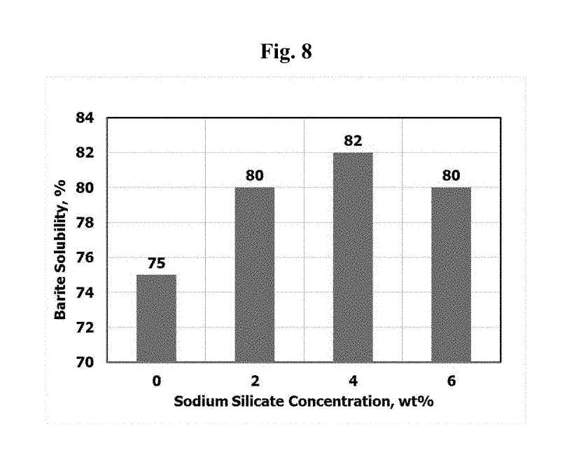

The presence of sodium silicate in the drilling fluid may affect a solubility of barite in the drilling fluid. For example, in one embodiment, the presence of the sodium silicate in traces amounts, i.e. in a range of 0.01-0.2% by weight, preferably 0.06-0.08%, preferably about 0.075% by weight, relative to the total weight of the drilling fluid, may increase a solubility of barite in the drilling fluid by at least 2%, preferably 5-10%, preferably 6-8%, relative to the solubility of barite in a drilling fluid that does not include sodium silicate, as shown in FIG. 8. In one embodiment, the solubility of barite in the drilling fluid is determined by measuring the amount of barite that is dissolved per 100 ml of a chelation-based solution (e.g. 10-30 wt %, preferably 20 wt % of an EDTA-containing solution) with a pH of 8 to 14, preferably 10 to 13, preferably 12, at a temperature of 150 to 250° F., preferably 180 to 220° F., preferably about 200° F. FIG. 7 is an image of an experimental set-up for measuring the solubility of barite in the drilling fluid.

In some embodiments, the drilling fluid may further include a silicate composition in addition to the sodium silicate. The silicate composition may be at least one selected from the group consisting of cesium silicate, potassium silicate, lithium silicate, and rubidium silicate. The silicate composition may be added to the drilling fluid to form a seal on a face of a wellbore, thereby providing a pressure necessary to carry out drilling operations. Accordingly, the silicate composition, when present, may have a mass concentration of no more than 0.3% by weight, preferably 0.2% by weight, preferably 0.15% by weight, relative to the total weight of the drilling fluid.

In one embodiment, the drilling fluid further include at least one additive selected from the group consisting of an antiscalant, a deflocculant, a lubricant, a crosslinker, a breaker, a fluid-loss control agent, a buffer, a surfactant, and a biocide.

The term “antiscalant” as used herein refers to an additive that prevents, slows, minimizes, and/or stops the precipitation of scale in the drilling fluid. Exemplary antiscalants that may be used in the drilling fluid include, without limitaion, phosphine, sodium hexametaphosphate, sodium tripolyphosphate and other inorganic polyphosphates, hydroxy ethylidene diphosphonic acid, butane-tricarboxylic acid, phosphonates, itaconic acid, 3-allyloxy-2-hydroxy-propionic acid, and the like. Preferably, a weight percent of the antiscalant, when present in the drilling fluid, is no more than 5.0 wt %, preferably no more than 2.0 wt %, preferably no more than 1.0 wt %, relative to the total weight of the drilling fluid.

The term “deflocculant” as used herein refers to an additive of the drilling fluid that prevents a colloid from coming out of suspensions or slurries. The deflocculant may further be used to adjust a viscosity of the drilling fluid. Exemplary deflocculants that may be used in the drilling fluid include, but are not limited to, an anionic polyelectrolyte, such as acrylates, polyphosphates, lignosulfonates (Lig), or tannic acid derivatives such as Quebracho. Preferably, a weight percent of the deflocculant, when present in the drilling fluid, is no more than 5.0 wt %, preferably no more than 2.0 wt %, preferably no more than 1.0 wt %, relative to the total weight of the drilling fluid.

The term “lubricant” as used herein refers to an additive of the drilling fluid that lowers a torque (by reducing a rotary friction) and lowers a drag (by reducing an axial friction) in a wellbore during a drilling operation. The lubricant may further lubricate drill-bit bearings if not sealed. The lubricant may be a synthetic oil or a bio-lubricant, such as those derived from plants and animals for example vegetable oils. Examples of synthetic oils that may be used in the drilling fluid include, but are not limited to, polyalpha-olefin (PAO), synthetic esters, polyalkylene glycols (PAG), phosphate esters, alkylated naphthalenes (AN), silicate esters, ionic fluids, multiply alkylated cyclopentanes (MAC). Exemplary vegetable oil-based lubricants (i.e. biolubricants) that may be used in the drilling fluid include, without limitation, canola oil, castor oil, palm oil, sunflower seed oil, rapeseed oil from vegetable sources, tall oil from tree sources, and the like. Preferably, a weight percent of the lubricant, when present in the drilling fluid, is no more than 5.0 wt %, preferably no more than 2.0 wt %, preferably no more than 1.0 wt %, relative to the total weight of the drilling fluid.

The term “crosslinker” as used herein refers to an additive of the drilling fluid that can react with multiple-strand polymers to couple the molecules together, thereby creating a highly viscous fluid, with a controllable viscosity. Exemplary crosslinkers that may be used in the drilling fluid include, but are not limited to, metallic salts, e.g. salts of Al, Fe, B, Ti, Cr, and Zr, or organic crosslinkers such as polyethylene amides and/or formaldehyde. Preferably, a weight percent of the crosslinker, when present in the drilling fluid, is no more than 2.0 wt %, preferably no more than 1.0 wt %, preferably no more than 0.5 wt %, relative to the total weight of the drilling fluid.

The term “breaker” as used herein refers to an additive of the drilling fluid that provides a desired viscosity reduction in a specified period of time, for example, by breaking long-chain molecules into shorter segments. Examples of the breakers that may be used in the drilling fluid include, but are not limited to, oxidizing agents such as sodium chlorites, sodium bromate, hypochlorites, perborate, persulfates, and peroxides, as well as enzymes. Preferably, a weight percent of the breaker, when present in the drilling fluid, is no more than 2.0 wt %, preferably no more than 1.0 wt %, preferably no more than 0.5 wt %, relative to the total weight of the drilling fluid.

The term “fluid-loss control agent” as used herein refers to an additive of the drilling fluid that controls/reduces a loss of the drilling fluid when pumped to a formation. Exemplary fluid-loss control agents that may be used in the drilling fluid include, but are not limited to starch, polysaccharides, silica flour, gas bubbles (energized fluid or foam), benzoic acid, soaps, resin particulates, relative permeability modifiers, degradable gel particulates, diesel or other hydrocarbons dispersed in fluid, and other immiscible fluids. Preferably, a weight percent of the fluid-loss control agent, when present in the drilling fluid, is no more than 5.0 wt %, preferably in the range of 0.01 to 4.0 wt %, preferably 0.05 to 3.0 wt %, preferably 0.1 to 2.0 wt %, preferably 0.5 to 1.5 wt %, preferably about 1.0 wt %, relative to the total weight of the drilling fluid.

The term “buffer” as used herein refers to an additive of the drilling fluid that is used to adjust the pH of the drilling fluid. Exemplary buffers that may be used in the drilling fluid include, but are not limited to, monosodium phosphate, disodium phosphate, sodium tripolyphosphate, and the like. Preferably, a weight percent of the buffer, when present in the drilling fluid, is no more than 2.0 wt %, preferably no more than 1.0 wt %, preferably no more than 0.5 wt %, relative to the total weight of the drilling fluid.

The term “surfactant” as used herein refers to an additive of the drilling fluid that lowers a surface tension (or an interfacial surface tension) between two immiscible fluids or between a fluid and a solid in the drilling fluid. The surfactant may be a nonionic surfactant, an anionic surfactant, a cationic surfactant, a gemini surfactant, a viscoelastic surfactant, or a zwitterionic surfactant. The surfactant may further provide a role of a water-wetting agent, a foamer, a detergent, a dispersant, or an emulsifier. In some embodiments, the surfactant may act as a corrosion inhibitor or a lubricant. Exemplary surfactants that may be used in the drilling fluid include, without limitation, alkanolamides, alkoxylated alcohols, alkoxylated amines, amine oxides, alkoxylated amides, alkoxylated fatty acids, alkoxylated fatty amines, alkoxylated alkyl amines (e.g., cocoalkyl amine ethoxylate), alkyl phenyl polyethoxylates, lecithin, hydroxylated lecithin, fatty acid esters, glycerol esters and their ethoxylates, glycol esters and their ethoxylates, esters of propylene glycol, sorbitan, ethoxylated sorbitan, polyglycosides, sulfonates, hydrolyzed keratin, sulfosuccinates, taurates, betaines, modified betaines, alkylamidobetaines (e.g., cocoamidopropyl betaine). The surfactant may be used in a liquid form or in a powder form. Preferably, a weight percent of the surfactant, when present in the drilling fluid, is preferably no more than 5.0 wt %, preferably no more than 2.0 wt %, preferably no more than 1.0 wt %, preferably 0.1 wt % to 0.5 wt %, relative to the total weight of the drilling fluid.

The term “biocide” as used herein refers to an additive of the drilling fluid that that kills bacteria and other microorganisms present in the drilling fluid. Exemplary biocides include, but are not limited to, phenoxyethanol, ethylhexyl glycerine, benzyl alcohol, methyl chloroisothiazolinone, methyl isothiazolinone, methyl paraben, ethyl paraben, propylene glycol, bronopol, benzoic acid, imidazolinidyl urea, a 2,2-dibromo-3-nitrilopropionamide, and a 2-bromo-2-nitro-1,3-propane diol. Preferably, a weight percent of the biocide, when present in the drilling fluid, is no more than 2.0 wt %, preferably no more than 1.0 wt %, relative to the total weight of the drilling fluid.

In certain embodiments, the drilling fluid may further include one or more additives selected from an alcohol, a glycol, an organic solvent, a soap, a fragrance, a dye, a dispersant, a water softener, a bleaching agent, an antifouling agent, an antifoaming agent, an anti-sludge agent, a catalyst, a corrosion inhibitor, a diverting agent, an oxygen scavenger, a sulfide scavenger, a retarder, a gelling agent, a permeability modifier, a bridging agent, a shale stabilizing agent (such as ammonium chloride, tetramethyl ammonium chloride, or cationic polymers), a clay treating additive, a polyelectrolyte, a freezing point depressant, an iron-reducing agent, etc. The aforementioned additives, when present, may have a mass concentration independently of 0.01-5% by weight, preferably 0.5-3% by weight, more preferably 0.8-2% by weight, relative to a total weight of the drilling fluid.

Thorough mixing of the continuous phase (i.e. the water-based fluid or the oil-based fluid), the viscosifier, the weighting agent, the sodium silicate, and the at least one additive, when present, is desirable to avoid formation of lumps or “fish eyes” in the drilling fluid. Accordingly, in a preferred embodiment, the viscosifier (e.g. bentonite) is thoroughly mixed with the water-based fluid and the weighting agent, and the sodium silicate is added to the water-based fluid thereafter. The drilling fluid may be stirred with a stirring speed of 1 to 800 rpm, or 5 to 700 rpm, or 10 to 600 rpm, to avoid formation of lumps or “fish eyes.” The drilling fluid may preferably be stirred for a sufficient amount of time to allow hydration of the viscosifier in the water-based fluid. This amount of time may preferably be between 5 and 60 minutes, preferably between 10 and 40 minutes, preferably between 20 and 30 minutes. The drilling fluid may be stirred for time durations outside of the aforementioned ranges to form a drilling fluid that is substantially free of lumps.

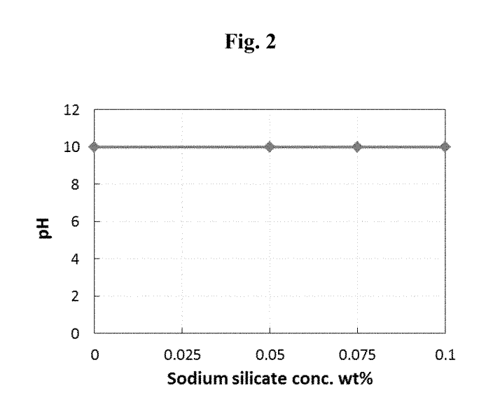

The pH of the drilling fluid may be adjusted according to drilling applications. For example, the pH of the drilling fluid may be adjusted so as to increase a solubility the additives that may be present in the drilling fluid (e.g. the deflocculant, the antiscalant, the lubricant, the biocide, etc.). In one embodiment, the pH of the drilling fluid is adjusted to be at least 9, preferably in the range of 9 and 14, preferably between about 9.5 and about 13, preferably between about 10 and 12, more preferably about 10. This pH range may also be advantageously suited for drilling operations where acid promoted damage/corrosion to equipment with metal parts is a concern. The pH of the drilling fluid is preferably not less than 7, preferably not less than 8. One or more of the buffers, as described previously, may be used to adjust the pH of the drilling fluid for certain drilling applications. The presence of the sodium silicate, at the above-mentioned concentrations, may preferably not affect the pH of the drilling fluid, as shown in FIG. 2.

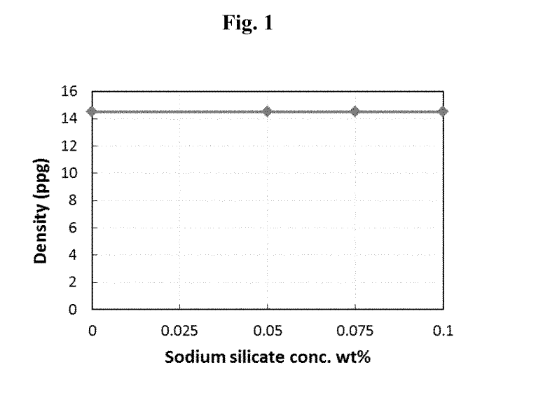

In one embodiment, the drilling fluid has a density of 13 to 16 ppg (pounds per gallon), preferably 13.5 to 15.5 ppg, preferably about 14.5 ppg, at room temperature (i.e. a temperature of 65 to 90° F., preferably 70 to 85° F.). In certain drilling applications, the density of the drilling fluid may be increased to a value of 16 to 20 ppg, preferably 17 to 19 ppg, by increasing the concentration of the weighting agent in the drilling fluid. The presence of the sodium silicate, at the above-mentioned concentrations, may preferably not affect the density of the drilling fluid, as shown in FIG. 1.

In some embodiments, rheological properties of the drilling fluids are determined using a HPHT rheometer by following ISO/API standard 10414. Accordingly, in some embodiments, the drilling fluid is prepared by mixing the following components, with a weight percent as shown in the parenthesis; i) water-based fluid (45-55% by weight), ii) soda ash, i.e. Na₂CO₃, (0.05-0.15% by weight), iii) a defoamer (less than 0.01% by weight), iv) bentonite (0.5-1.5% by weight), v) XC polymer (0.1-0.3% by weight), vi) caustic soda, i.e., NaOH (0.03-0.06% by weight), vii) sodium chloride (3-5% by weight), viii) starch (0.5-1.5% by weight), ix) calcium carbonate (0.5-1.5% by weight), x) barite (45-55% by weight). The drilling fluid may preferably be stirred for at least 20 minutes, preferably at least 30 minutes, at a temperature of 65 to 90° F., preferably 70 to 85° F., and atmospheric pressure. Drilling fluid parameters are measured as follows:

Plastic viscosity (PV, cP)=600 dial (i.e. rpm reading)−300 dial

Yield point (YP, lb/100 ft²)=300 dial−plastic viscosity

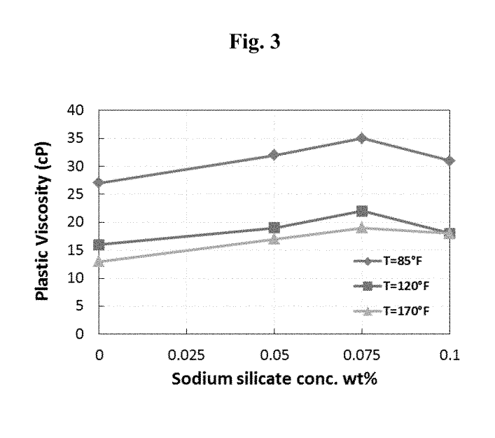

Gel Strength (GS, lb/100 ft²) is measured by taking a 3 rpm reading, allowing the drilling fluid to set for 10 seconds (referred to as a “ten-second gel strength”) or for 10 minutes (referred to as a “ten-minute gel strength”). Since the above parameters are interrelated, once an acceptable plastic viscosity is obtained, other values may be determined subsequently. Preferably, the plastic viscosity, the yield strength, and the gel strength, are measured at a room temperature i.e. a temperature of 65 to 90° F., preferably 70 to 85° F., or at an elevated temperature i.e. a temperature of 100 to 180° F., preferably 120 to 170° F.; and atmospheric pressure (i.e. a pressure of 0.8 to 1.2 atm, preferably 0.9 to 1.1 atm, preferably about 1.0 atm). Results of plastic viscosity, yield strength, and gel strength of the drilling fluid at various sodium silicate concentrations and the above-mentioned temperatures are individually shown in FIGS. 3-6.

In view of the results, in some embodiments, the drilling fluid has a plastic viscosity of 25 to 40 cP, preferably 30 to 35 cP, at a temperature of 65 to 90° F., preferably 70 to 85° F. The presence of the sodium silicate, at the above-mentioned concentrations, may preferably increase the plastic viscosity of the drilling fluid, at the above-mentioned temperatures, by at least 5%, preferably 10-20%, preferably 12-15%, relative to the plastic viscosity of a drilling fluid that does not include sodium silicate, as shown in FIG. 3. Also, the drilling fluid has a plastic viscosity of 15 to 25 cP, preferably 18 to 22 cP, at a temperature of 100 to 180° F., preferably 120 to 170° F. The presence of the sodium silicate, at the above-mentioned concentrations, may preferably increase the plastic viscosity of the drilling fluid, at the above-mentioned temperatures, by at least 2%, preferably 5-15%, preferably 8-12%, relative to the plastic viscosity of a drilling fluid that does not include sodium silicate, as shown in FIG. 3.

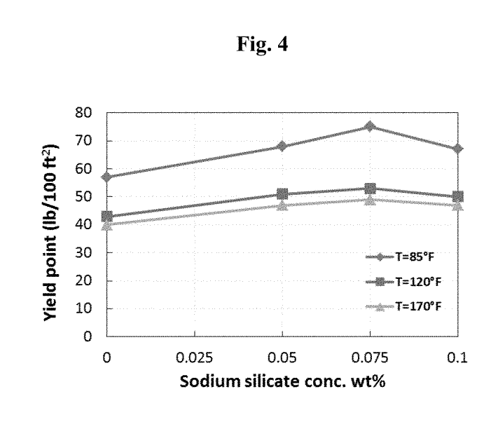

In one embodiment, the drilling fluid has a yield point of 65 to 80 lb/100 ft², preferably 68 to 78 lb/100 ft² at a temperature of 65 to 90° F., preferably 70 to 85° F. The presence of the sodium silicate, at the above-mentioned concentrations, may preferably increase the yield point of the drilling fluid, at the above-mentioned temperatures, by at least 5%, preferably 10-20%, preferably 12-15%, relative to the yield point of a drilling fluid that does not include sodium silicate, as shown in FIG. 4. Also, the drilling fluid has a yield point of 45 to 55 lb/100 ft², preferably 48 to 54 lb/100 ft² at a temperature of 100 to 180° F., preferably 120 to 170° F. The presence of the sodium silicate, at the above-mentioned concentrations, may preferably increase the yield point of the drilling fluid, at the above-mentioned temperatures, by at least 2%, preferably 5-15%, preferably 8-12%, relative to the yield point of a drilling fluid that does not include sodium silicate, as shown in FIG. 4.

In one embodiment, the drilling fluid has a yield point to plastic viscosity (YP/PV) ratio of 2.4:1 to 3.0:1, preferably 2.45:1 to 2.6:1, more preferably about 2.5:1 at a temperature of 100 to 180° F., preferably 120 to 170° F. The presence of the sodium silicate, at the above-mentioned concentrations, may preferably increase the YP/PV ratio of the drilling fluid, at the above-mentioned temperatures, by at least 10%, preferably 15-25%, preferably about 20%, relative to the YP/PV ratio of a drilling fluid that does not include sodium silicate.

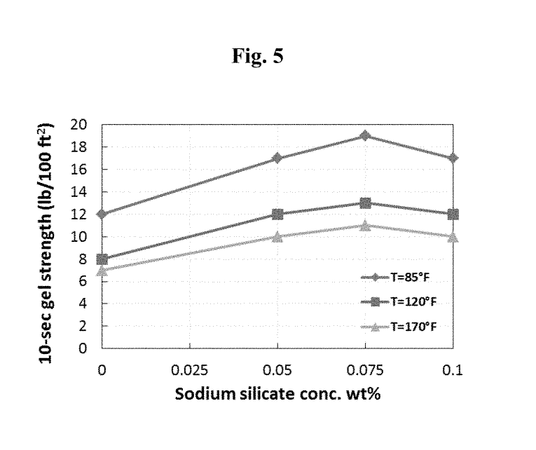

In one embodiment, the drilling fluid has a ten-second gel strength of 15 to 20 lb/100 ft², preferably 18 to 20 lb/100 ft² at a temperature of 65 to 90° F., preferably 70 to 85° F. The presence of the sodium silicate, at the above-mentioned concentrations, may preferably increase the ten-second gel strength of the drilling fluid, at the above-mentioned temperatures, by at least 2%, preferably 5-10%, preferably 6-8%, relative to the ten-second gel strength of a drilling fluid that does not include sodium silicate, as shown in FIG. 5. Also, the drilling fluid has a ten-second gel strength of 10 to 15 lb/100 ft², preferably 12 to 15 lb/100 ft² at a temperature of 100 to 180° F., preferably 120 to 170° F. The presence of the sodium silicate, at the above-mentioned concentrations, may preferably increase the ten-second gel strength of the drilling fluid, at the above-mentioned temperatures, by 1-10%, preferably 2-5%, relative to the ten-second gel strength of a drilling fluid that does not include sodium silicate, as shown in FIG. 5.

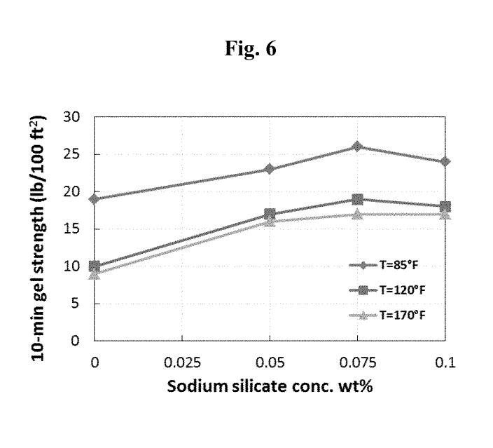

In one embodiment, the drilling fluid has a ten-minute gel strength of 20 to 25 lb/100 ft², preferably 22 to 25 lb/100 ft² at a temperature of 65 to 90° F., preferably 70 to 85° F. The presence of the sodium silicate, at the above-mentioned concentrations, may preferably increase the ten-minute gel strength of the drilling fluid, at the above-mentioned temperatures, by at least 2%, preferably 5-10%, preferably 6-8%, relative to the ten-minute gel strength of a drilling fluid that does not include sodium silicate, as shown in FIG. 6. Also, the drilling fluid has a ten-minute gel strength of 15 to 20 lb/100 ft², preferably 18 to 20 lb/100 ft², at a temperature of 100 to 180° F., preferably 120 to 170° F. The presence of the sodium silicate, at the above-mentioned concentrations, may preferably increase the ten-minute gel strength of the drilling fluid, at the above-mentioned temperatures, by at least 5%, preferably 5-15%, preferably 8-12%, relative to the ten-minute gel strength of a drilling fluid that does not include sodium silicate, as shown in FIG. 6.

In one embodiment, the drilling fluid has a corrosion rate of 0.00001-0.01 lb/ft², preferably 0.0001-0.005 lb/ft², more preferably 0.0005-0.001 lb/ft² per 6 hours in contact with a steel surface at a temperature of 100-200° C., preferably 120-170° C., more preferably 130-160° C. and a pressure of 200-400 psi, preferably 250-350 psi. Here, the corrosion rate uses a unit of lb/ft² as a measure of the corrosion weight loss in pounds mass per square foot of pre-exposed surface area. The unit may also be written as lbm/ft², where “lbm” denotes pounds as a mass unit, rather than pounds as a force unit. The corrosion rate may be measured in a controlled environment by weighing a piece of steel, such as a steel coupon, measuring its surface area, contacting it with a corrosive agent for a certain time and at a certain temperature and pressure, removing the corrosive agent, and again weighing the piece of steel in order to find the corrosive weight loss. The coupon may be a strip, a disc, or a cylinder, or may be some other shape designed for a testing cell or a part of a drill pipe, such as a joint between segments. Alternatively, the corrosion rate of the composition in contact with a steel surface may be measured in units of mils/yr, (also denoted as MPY, mils penetration per year) which is a decrease in thickness in mils of a surface due to a corrosion loss over one year. In one embodiment, a corrosion rate of the drilling fluid when brought into a contact with a steel surface for 6 hours at a temperature of 100-200° C., preferably 120-170° C., more preferably 130-160° C. and a pressure of 200-400 psi, preferably 250-350 psi is 10-500 mils/yr, preferably 15-200 mils/yr, more preferably 20-50 mils/yr. In one embodiment, a corrosion rate of the drilling fluid is determined by following ASTM G205-16.

According to a second aspect, the present disclosure relates to a method of drilling a subterranean geological formation (also referred to as “formation” in this disclosure). The term “subterranean geological formation” as used here preferably refers to a tight formation (also referred to as “unconventional formation” in this disclosure), which has a permeability of no more than 0.1 millidarcy (mD), preferably in the range of 0.001 to 0.1 mD, more preferably 0.01 to 0.1 mD. Various methods, as known to those skilled in the art, may be employed to determine the permeability of the subterranean geological formation. For example, in one embodiment, a well logging tool is employed to determine the permeability of the subterranean geological formation.

The subterranean geological formation may be a carbonate formation, a sandstone formation, a shale formation, a clay formation, etc. In a preferred embodiment, the subterranean geological formation is a sandstone formation, for example, a formation which contains quartz, feldspar, rock fragments, mica and numerous additional mineral grains held together with silica and/or cement. In one embodiment, the subterranean geological formation is a carbonate formation, e.g. limestone or dolostone, which contains carbonate minerals, such as calcite, aragonite, dolomite, etc. In another embodiment, the subterranean geological formation is a shale formation, which contains clay minerals and quartz. Yet in another embodiment, the subterranean geological formation is a clay formation, which contains chlorite, illite, kaolinite, montmorillonite and smectite.

The method involves drilling the subterranean geological formation to form a wellbore therein. In some embodiments, the drilling comprises identifying a site of interest, and then creating a starter hole in the ground at that site. Then, a drill bit, which may be coupled to a hydraulic pump, is driven through the starter hole. The drill bit and the hydraulic pump are not meant to be limiting and various types of drill bits and hydraulic pumps, as known to those skilled in the art, may be utilized here. The wellbore may be drilled to a depth of at least 20 m, preferably at least 100 m, preferably at least 500 m, preferably 1,000 m to 3,000 m, preferably 1,500 m to 2,500 m.

A formation fluid may be produced during or after the drilling. The formation fluid may be one or more of a sour and/or sweet natural gas, a sour and/or sweet crude oil, gas condensate, water, etc. A composition of the formation fluid, which may be produced during or preferably after the drilling, depends on the type of the subterranean geological formation. For example, in some preferred embodiments, the subterranean geological formation is a tight (i.e. an unconventional) formation with a permeability of less than 0.1 mD, wherein the formation fluid preferably contains various combinations of natural gas (i.e., primarily methane). The formation fluid may further contain light hydrocarbon and/or non-hydrocarbon gases (including condensable and non-condensable gases). Exemplary non-condensable gases include hydrogen, carbon monoxide, carbon dioxide, methane, and other light hydrocarbons. In certain embodiments, the subterranean geological formation has a permeability of more than 0.1 mD, preferably 0.1 to 10 mD, preferably 0.2 to 1.0 mD, wherein the formation fluid may contain light hydrocarbon liquids, heavy hydrocarbon liquids, crude oil, rock, oil shale, bitumen, oil sands, tar, coal, and/or water. In some other embodiments, the formation fluid may be in the form of a gaseous fluid, a liquid, or a double-phase fluid (i.e. containing a gaseous phase and a liquid phase).

The subterranean geological formation may be drilled using different protocols, as known to those skilled in the art, to form a vertical wellbore, a horizontal wellbore, a multilateral wellbore, or a maximum reservoir contact (MRC) wellbore. As used here, a horizontal wellbore refers to a wellbore that has a vertical section and a horizontal lateral section with an inclination angle (an angle between the vertical section and the horizontal lateral section) of at least 70°, or at least 80°, or in the range of 85° to 90°. The horizontal wellbore may enhance a reservoir performance due to an increased reservoir contact provided by the horizontal lateral section. As used here, a multilateral wellbore refers to a wellbore that has a main/central borehole and a plurality of laterals extend outwardly therefrom. As used here, a maximum reservoir contact wellbore is one type of directional wellbore that provides an aggregate reservoir contact of at least 2 km, or at least 5 km, or preferably about 6 to about 8 km, through a single or a multi-lateral configuration.

In one embodiment, a downhole temperature of the wellbore is no more than 300° F., preferably no more than 250° F., preferably from about 100 to 200° F., preferably 110 to 180° F. In some embodiments, the wellbore is a horizontal wellbore and the temperature may not vary significantly along a horizontal lateral section of the wellbore. In view of the above-mentioned downhole temperatures, the drilling fluid may preferably operate as intended, without a substantial change in any of the plastic viscosity, the yield strength, and the gel strength, as measured at the elevated temperature.

During the drilling, the drilling fluid is circulated in the wellbore to lubricate and/or cool the drill bit and to further remove drilling cuttings. In some embodiments, the drilling fluid is circulated at a flow rate ranging from 1 to 50 L/s, preferably 5 to 40 L/s, preferably 12 to 26 L/s, preferably 15 to 22 L/s, more preferably 17 to 20 L/s. In view of that, a total volume of the drilling fluid that is circulated in the wellbore may vary from about 1,000 to 500,000 L, preferably 2,000 to 400,000 L, preferably 3,000 to 300,000 L. A location in the wellbore where the drilling fluid is circulated may vary depending on the type of the wellbore. For example, in one embodiment, the wellbore is a vertical wellbore and the drilling fluid is circulated in at least a portion of a vertical section of the wellbore, e.g. from a top surface of the wellbore to a toe. In another embodiment, the wellbore is a horizontal wellbore with a horizontal lateral section, wherein the drilling fluid is only circulated in at least a portion of the horizontal lateral section. In another embodiment, the wellbore is a multilateral wellbore with a main/central borehole and a plurality of laterals extend outwardly therefrom, wherein the drilling fluid is circulated in the main/central borehole and/or at least one of the laterals.

The drilling fluid may be heated or cooled before circulating in the wellbore. Accordingly, in some embodiments, a temperature of the drilling fluid may be raised to a value of 100 to 200° F., preferably 110 to 180° F., before circulating the drilling fluid in the wellbore. Alternatively, the drilling fluid may be cooled to a temperature of 40 to 60° F., preferably 45 to 55° F. A person having ordinary skill in the art may be able to determine appropriate temperatures for the drilling fluid before the drilling.

Depending on the type of the subterranean geological formation, the drilling fluid may interact with the formation. For example, in one embodiment, the subterranean geological formation is a sandstone formation, wherein the drilling fluid reacts with soluble substances in the formation.

In some embodiments, for economic and environmental reasons, the drilling fluid may be cleaned/filtered and further recirculated. In view of that, large drill cuttings are preferably removed via a sieving process, for example, by passing the drilling fluid through one or more vibrating screens, and optionally fine cuttings are removed by passing the drilling fluid through centrifuges or screens with small mesh sizes. Then, the drilling fluid may preferably be recirculated to the wellbore.

The presence of the sodium silicate, at the above-mentioned concentrations, may substantially reduce a percent loss of the drilling fluid. For example, in a preferred embodiment, the continuous phase of the drilling fluid is the water-based fluid, wherein a percent loss of the drilling fluid during the circulating is no more than 5% by volume, preferably no more than 4% by volume, preferably no more than 3% by volume, relative to the total volume of the drilling fluid. A percent loss of the drilling fluid during the drilling may further be reduced by adding the fluid-loss control agent, as described previously. For example, in some embodiments, the drilling fluid contains a fluid-loss control agent at a mass concentration of 0.01-2 wt %, preferably 0.5-1.5 wt %, more preferably 0.8-1.2 wt %, relative to a total weight of the drilling fluid. In view of that, a percent loss of the drilling fluid with the fluid-loss control agent during the drilling may preferably be no more than 2.0 vol %, preferably no more than 1.0 vol %, preferably no more than 0.5 vol %, relative to the total volume of the drilling fluid that is circulated. The term “percent loss” as used herein refers to a volume percentile of the continuous phase (e.g. the water-based fluid) which is leaked during a drilling operation, relative to the total volume of the drilling fluid that is circulated.

Duration of a drilling operation may vary from about 10 minutes to about 6 hours, preferably 20 minutes to 5 hours, preferably 30 minutes to about 4 hours. In certain embodiments, the drilling fluid is circulated within the wellbore for at least 30 minutes, preferably at least 1 hour but no more than 6 hours, preferably 2 to 4 hours, preferably 2.5 to 3.5 hours.

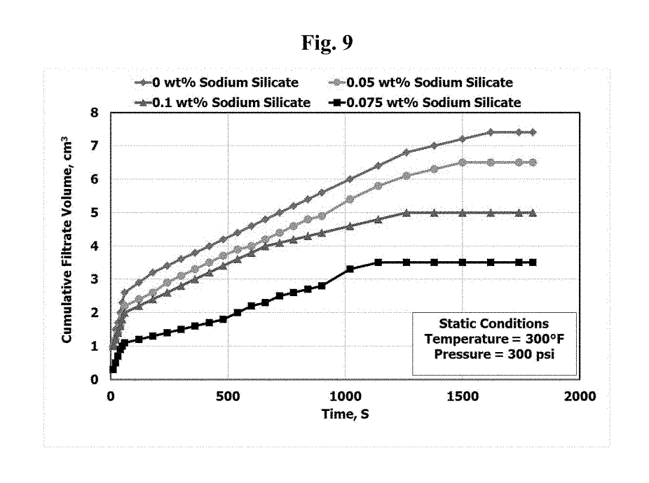

In one embodiment, the drilling fluid is circulated in the wellbore for no more than 1 hour, preferably about 10 minutes to about 50 minutes, preferably about 20 minutes to about 40 minutes, preferably about 30 minutes, at a temperature of 250 to 350° F., preferably about 300° F., and under a pressure of 250 to 350 psi, preferably about 300 psi, wherein a total fluid loss (or a cumulative filtrate volume) of the drilling fluid is no more than 10%, preferably no more than 8%, preferably no more than 6%, preferably no more than 4%, relative to the total volume of the drilling fluid which is circulated. The presence of the sodium silicate, at the above-mentioned concentrations, may reduce the total fluid loss of the drilling fluid by at least 10%, preferably at least 20%, preferably 40-60%, relative to the total fluid loss of a drilling fluid that does not include sodium silicate, as shown in FIG. 9.

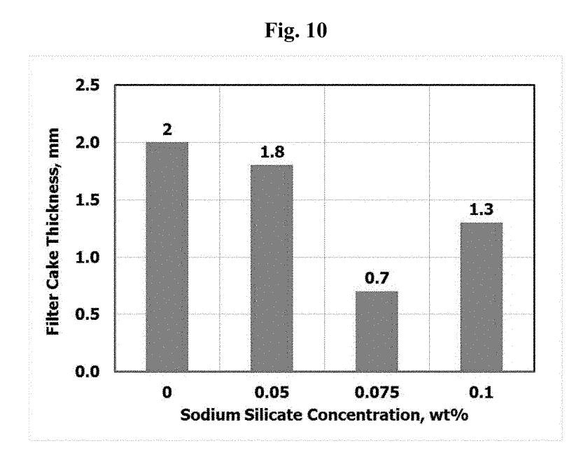

In one embodiment, the drilling fluid is circulated in the wellbore for no more than 1 hour, preferably about 10 minutes to about 50 minutes, preferably about 20 minutes to about 40 minutes, preferably about 30 minutes, wherein circulating the drilling fluid in the wellbore forms a filter cake with a thickness of no more than 2 mm, preferably no more than 1.8 mm. The presence of the sodium silicate, at the above-mentioned concentrations, may preferably reduce a thickness of the filter cake by at least 10%, preferably at least 20%, preferably at least 30%, preferably 40-70%, relative to the thickness of a filter cake that forms after using a drilling fluid that does not include sodium silicate. The thickness of filter cakes that form after using drilling fluids with various concentrations of sodium silicate are shown in FIG. 10.

In view of the thickness of the filter cake, the method may or may not involve a step of removing the filter cake.

In one embodiment, the wellbore is a cased wellbore (e.g. with a cement casing), and the filter cake (or at least a portion of the filter cake) may be formed on the cement casing, wherein the thickness of the filter cake is less than 2 mm, preferably less than 1.5 mm, preferably less than 1.0 mm, wherein the method does not involve a step of removing the filter cake. The presence of the sodium silicate and/or the silicate composition may provide a good sealing between the filter cake and the cement casing. In another embodiment, the wellbore is an uncased wellbore (i.e. an open borehole), and the thickness of the filter cake is less than 2 mm, preferably less than 1.5 mm, preferably less than 1.0 mm, wherein the method does not involve a step of removing the filter cake. Accordingly, the filter cake may preferably be removed (or at least partially removed) by an influx pressure of the formation fluids during a production of the wellbore. When the filter cake is partially removed, a residual filter cake may preferably not substantially affect the permeability of the formation and thus may not reduce a production rate of the wellbore.

In another embodiment, the method further involves removing the filter cake from the wellbore, which may be a cased wellbore or an open borehole. Accordingly, the filter cake in the wellbore may first be contacted with a filter-cake removing composition. The filter-cake may be soaked in or exposed to the filter-cake removing composition for 18-30 h, preferably 20 to 24 hours, wherein the filter cake (or at least a portion of the filter cake, e.g., at least 80 wt %, preferably at least 90 wt % of the filter cake, relative to an initial weight of the filter cake) is dispersed/dissolved in the filter-cake removing composition. After contacting the filter-cake removing composition with the filter cake, in one embodiment, a dispersed filter cake, which may be formed after contacting the filter-cake removing composition with the filter cake, is flushed away. In one embodiment, the filter-cake removing composition contains 15-25% by weight, preferably about 20% by weight of a chelating agent, e.g. EDTA, 5-10% by weight, preferably about 6% by weight of potassium carbonate, and less than 1.0% by weight, preferably less than 0.5% by weight of an enzyme, with a balance of water, each relative to the total weight of the filter-cake removing composition.

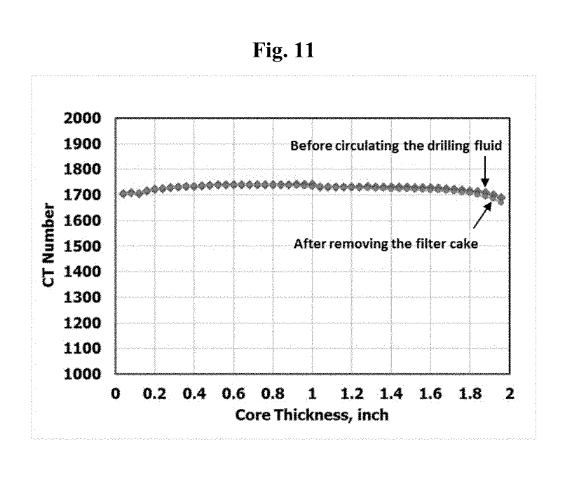

The permeability of the subterranean geological formation after removing the filter cake may be reduced by no more than 10%, preferably no more than 5%, preferably no more than 3%, relative to the permeability of the subterranean geological formation before circulating the drilling fluid. In some preferred embodiments, the permeability of the subterranean geological formation after removing the filter cake is substantially the same as the permeability of the subterranean geological formation before circulating the drilling fluid, as shown in FIG. 11, which is a computer tomography scan of the formation before circulating the drilling fluid and after removing the filter cake. In a preferred embodiment, an average permeability of a formation is 0.01 to 0.1 mD, preferably 0.05 to 0.09 mD before circulating the drilling fluid. After circulating the drilling fluid and removing the filter cake, an average permeability of the formation is remained almost unchanged i.e. in the range of 0.01 to 0.1 mD, preferably 0.05 to 0.09 mD. Accordingly, the drilling fluid may preferably provide a substantially zero-solid invasion for the unconventional formations with permeability of no more than 0.1 millidarcy (mD), preferably in the range of 0.001 to 0.1 mD, more preferably 0.01 to 0.1 mD. As used here, a drilling fluid with a substantially zero-solid invasion refers to a drilling fluid that provides a retained permeability of at least 90%, preferably at least 95%, preferably at least 99%, preferably 100%. The term “retained permeability” as used in this disclosure relates to a ratio of the permeability of a formation after removing the filter cake to the permeability of the formation before circulating the drilling fluid.

The examples below are intended to further illustrate protocols for the drilling fluid, and are not intended to limit the scope of the claims.

### Example 1—Water-Based Drilling Fluid

The following examples provide a proper non-damaging water-based drilling fluid for tight reservoirs to prevent fluid invasion and water blockage issues. The drilling fluid forms a thin, impermeable, and easily removable filter cake.

The drilling fluid consists of distilled water as a continues phase, 5 g of bentonite and 1 g of xanthan gum to control viscosity, 0.25 g of caustic soda to control the pH, 22 g of sodium chloride for shale stabilization and increase the density, 4 g of starch for filtration and viscosity control, 3 g of 25 micron-size calcium carbonate and 3 g of 38 micron-size calcium carbonate, and 278 g of barite as a weighting agent. The drilling fluid was prepared and mixed at room temperature and atmospheric conditions. Table 1 lists the composition of the drilling fluid.

TABLE 1
Composition of the drilling fluid

| Additives | Amount |
|---|---|
| Distilled Water | 241.5 g |
| Soda Ash (Na₂CO₃) | 0.5 g |
| De-foamer | 0.01 g |
| Bentonite | 5 g |
| XC Polymer | 1 g |
| Caustic Soda (NaOH) | 0.25 g |
| Sodium Chloride (NaCl) | 22 g |
| Starch | 4 g |
| CaCO₃ | 6 g |
| Barite | 278 g |

The rheological properties of the drilling fluid were measured at room temperature (85° F.) and the results are listed in Table 2.

TABLE 2
Rheological properties of the drilling fluid at room temperature

| Properties | Value |
|---|---|
| Density, ppg | 14.5 |
| Plastic viscosity, cP | 27 |
| Yield point, lb/100 ft² | 57 |
| 10 s gel strength, lb/100 ft² | 12 |
| 10 min gel strength, lb/100 ft² | 19 |
| pH | 10 |
| Yield point to plastic viscosity | 2.11 |

### Example 2—Effect of Adding Sodium Silicate

Various concentrations of sodium silicate were added to the drilling fluid, and the rheological properties were separately measured at room temperature (i.e. 85° F.), at 120° F., and at 170° F. These results are separately shown in FIGS. 3-6.

FIGS. 1 and 2 indicate that adding sodium silicate does not affect the density and the pH of the drilling fluid at room temperature. The density of the drilling fluid was 14.5 ppg and it remained constant after adding 0.05, 0.075, and 0.1 wt % of sodium silicate. The same behavior was observed for the pH of the drilling fluid.

FIG. 3 shows that the plastic viscosity of the drilling fluid was increased from 27 cP to 32 cP after adding 0.05 wt % of sodium silicate. The plastic viscosity was further increased to 35 after adding 0.075 wt % of sodium silicate, whereas it was decreased to 31 cP after adding 0.1 wt % of sodium silicate.

In addition, yield point of the drilling fluid was increased from 57 to 68 lb/100 ft² after adding 0.05 wt % of sodium silicate. The yield point was further increased to 75 after adding 0.075 wt % of sodium silicate, whereas it was decreased to 67 after adding 0.1 wt % of sodium silicate. Similar trends were observed for the 10 s and 10 min gel strength, respectively, implying that 0.075 wt % is a preferred concentration of the sodium silicate in the drilling fluid.

### Example 3—Effect of Temperature and Sodium Silicate Concentration

Moreover, a HPHT rheometer was used to measure the change in the rheological properties of the drilling fluid at various concentrations of sodium silicate, at 120 and 170° F.

FIGS. 3-6 show that adding sodium silicate at different concentrations (0.05 to 0.1 wt %) enhanced the rheological properties of the drilling fluid when compared with the rheological properties of a drilling fluid that does not contain sodium silicate. According to the results, as shown in FIGS. 3-6, the trends of the yield point, the plastic viscosity, the 10 s, and, the 10 min gel strength, were observed to be similar to the trends observed in the rheological properties of the drilling fluid at room temperature. This also shows that 0.075 wt % is a preferred concentration of the sodium silicate in the drilling fluid. The yield point to plastic viscosity ratio (YP/PV) was found to be about 2.5 at 120° F.

Additionally, FIGS. 3-6 represent the plastic viscosity, the yield point, the ten-second gel strength, and the ten-minute gel strength of the drilling fluid at 170° F., at various concentration of the sodium silicate. According to the results, the trends of the yield point, the plastic viscosity, the 10 s, and, the 10 min gel strength, were found to be similar to the trends observed in the rheological properties of the drilling fluid at room temperature, and at 120° F. In view of that, 0.075 wt % is a preferred concentration of the sodium silicate in the drilling fluid at both the room temperature and elevated temperatures (i.e. 120° F. and 170° F.).

### Example 4—Effect of Sodium Silicate on Barite Solubility

To evaluate the effect of adding sodium silicate on barite solubility, a hot plate magnetic stirrer was used at 200° F., as shown in FIG. 7. The solubility test was performed using 4 gm of barite in 100 ml solution which contains 20 wt % EDTA at pH 12, and 6 wt % potassium carbonate. According to FIG. 8, the solubility of the barite at 200° F. was found to be around 75 wt % before adding sodium silicate.

The barite solubility was increased to 80% after adding 2 wt % of sodium silicate, and it was further increased to 82% after adding 4 wt % of sodium silicate. However, the barite solubility was decreased to 80% after adding 6 wt % of sodium silicate.

### Example 5—Effect of Sodium Silicate on Filtration

A high pressure high temperature filter press was used to perform the filtration test at 300 psi differential pressure and 300° F. using a 0.25 in. thickness tight sandstone core. FIG. 9 shows that the cumulative filtrate volume after 30 minutes of filtration was around 7.4 cm³ when a drilling fluid without having sodium silicate was used. The cumulative volume filtration was decreases to 6.5 cm³ when a drilling fluid with 0.05 wt % of sodium silicate was used. Further increase of sodium silicate to 0.075 wt % revealed a more reduction in the cumulative filtrate volume to 3.5 cm³, whereas a drilling fluid with 0.1 wt % of sodium silicate revealed a cumulative filtrate volume of 5 cm³.

The filter cake thickness was also measured after every filtration test. The filter cake thickness was around 2 mm when using zero percent of sodium silicate. By increasing the concentration of sodium silicate to 0.05 wt %, the filter cake thickness decreased to 1.8 mm. The cake thickness was decreased to 0.7 mm after increasing the sodium silicate concentration to 0.075 wt %. A further increase of sodium silicate to 0.1 wt % revealed a cake thickness of around 1.3 mm. The result of the filtration test implies that 0.075 wt % is a preferred concentration of the sodium silicate in the drilling fluid.

### Example 6—Retained Permeability

The filter cake (which was formed after using a drilling fluid with 0.075 wt % sodium silicate) was removed by soaking the filter cake with a filter-cake removal fluid that contains 20 wt % of EDTA, 6 wt % of potassium carbonate and enzyme. The filter cake was completely removed after 48 hrs of soaking at 300 psi and 300° F. using 2 in. tight sandstone core.

The initial permeability of sandstone core was measured using Darcy's law. The time required to flow of 200 cm³ of 3 wt % KCl solution at room temperature and at a constant pressure of 60 psi was recorded. The same procedure was performed after the removal of the filter cake to calculate the final permeability. Darcy's law (Eq. 2) was used to determine the initial permeability of sandstone core

$$k = \frac{122.812 * q * µ * h}{Δ p * {d}^{2}} \qquad ( 1 )$$

where

d=diameter through which water flow, in.

h=disk thickness, in.

K=permeability of the disk, md

q=flow rate, cm³/min

μ=fluid viscosity, cP

Δp=differential pressure, psi

The time required to flow 200 cm³ at a constant pressure of 60 psi was recorded. This procedure was repeated four times and the average permeability was calculated. The same procedure was performed after the removal of the filter cake to calculate the final permeability. The retained permeability was calculated as follows:

$${k}_{r} = \frac{{k}_{f}}{{k}_{i}} \times 100 \qquad ( 2 )$$

where

k_{f}=final permeability, md

kᵢ=initial permeability, md

kᵣ=retained permeability

For Berea sandstone cores, the retained permeability was found to be 100%. The experiment was repeated three times and the same results were obtained. This result confirmed the complete removal of the filter cake. To confirm the retained permeability results, a computer tomography scan was used to compare the state of the core before the filtration test and after the removal of the filter cake. Accordingly, FIG. 11 represents a computer tomography scan of a tight sandstone core before circulating the drilling fluid and after removing the filter cake. The distribution of the CT number (CTN) through the saturated core was found to be very close to the CTN of the core after the removal process, indicating the removal of the filter cake and the removal of the internal damage during the filtration operations.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method of drilling a subterranean geological formation with a permeability of no more than 0.1 millidarcy, the method comprising:
drilling the subterranean geological formation to form a wellbore therein; and
circulating a drilling fluid in the wellbore,
wherein the drilling fluid comprises:
a continuous phase selected from the group consisting of a water-based fluid and an oil-based fluid,
a viscosifier,
a weighting agent, and
sodium silicate, which is present in the drilling fluid at a concentration of 0.01-0.2% by weight, relative to the total weight of the drilling fluid,
wherein the drilling fluid does not contain a retarder; and
wherein during the circulating a filter cake comprising the weighting agent is formed on a wall of the wellbore.

2. The method of claim 1, wherein the sodium silicate is present in the drilling fluid at a concentration of 0.06-0.08% by weight, relative to the total weight of the drilling fluid.

3. The method of claim 1, wherein the subterranean geological formation is a sandstone formation.

4. The method of claim 1, wherein circulating the drilling fluid in the wellbore is carried out for no more than 1 hour.

5. The method of claim 1, wherein the viscosifier is bentonite, which is present in the drilling fluid at a concentration of 0.1-10% by weight, relative to the total weight of the drilling fluid.

6. The method of claim 1, wherein the weighting agent is barite, which is present in the drilling fluid at a concentration of 40-60% by weight, relative to the total weight of the drilling fluid.

7. The method of claim 1, wherein the drilling fluid further comprises at least one additive selected from the group consisting of an antiscalant, a deflocculant, a lubricant, a crosslinker, a breaker, a fluid-loss control agent, a buffer, a surfactant, and a biocide.

8. The method of claim 1, wherein the continuous phase is the water-based fluid.

9. The method of claim 8, wherein a percent loss of the drilling fluid during the circulating is no more than 5% by volume, relative to the total volume of the drilling fluid.

10. The method of claim 8,
wherein circulating the drilling fluid in the wellbore is carried out for no more than 1 hour, and
wherein a thickness of the filter cake is no more than 2 mm.

11. The method of claim 1, which does not involve a step of removing the filter cake.

12. The method of claim 1, further comprising:
removing the filter cake from the wellbore,
wherein the permeability of the subterranean geological formation after the removing is reduced by no more than 10%, relative to the permeability of the subterranean geological formation before the circulating.

13. The method of claim 1, further comprising:
removing the filter cake from the wellbore,
wherein the permeability of the subterranean geological formation after the removing is substantially the same as the permeability of the subterranean geological formation before the circulating.

14. The method of claim 8, wherein the drilling fluid has a pH of at least 9.

15. The method of claim 8, wherein the drilling fluid has a density of 13 to 16 ppg at a temperature of 65 to 90° F.

16. The method of claim 8, wherein the drilling fluid has a plastic viscosity of 25 to 40 cP at a temperature of 65 to 90° F., and a plastic viscosity of 15 to 25 cP at a temperature of 100 to 180° F.

17. The method of claim 8, wherein the drilling fluid has a yield point of 65 to 80 lb/100 ft² at a temperature of 65 to 90° F., and a yield point of 45 to 55 lb/100 ft² at a temperature of 100 to 180° F.

18. The method of claim 8, wherein the drilling fluid has a yield point to plastic viscosity ratio of 2.4:1 to 3.0:1, at a temperature of 100 to 180° F.

19. The method of claim 8,
wherein the drilling fluid has a ten-second gel strength of 15 to 20 lb/100 ft² at a temperature of 65 to 90° F., and a ten-second gel strength of 10 to 15 lb/100 ft² at a temperature of 100 to 180° F., and
wherein the drilling fluid has a ten-minute gel strength of 20 to 25 lb/100 ft² at a temperature of 65 to 90° F., and a ten-minute gel strength of 15 to 20 lb/100 ft² at a temperature of 100 to 180° F.

20. (canceled)
